(19) United States
(12) Patent Application Publication
(10) Pub. No.: US 2017/0005984 A1
(43) Pub. Date: Jan. 5, 2017

(54) SCALABLE ACCESS TO FIREWALL-PROTECTED RESOURCES

(71) Applicant: Akiri Solutions, Inc., Palo Alto, CA (US)

(72) Inventors: Matthew R. LAUE, Joshua Tree, CA (US); D. Timothy FLAGG, Palo Alto, CA (US)

(73) Assignee: Akiri Solutions, Inc., Palo Alto, CA (US)

(21) Appl. No.: 15/080,223

(22) Filed: Mar. 24, 2016

Related U.S. Application Data
(60) Provisional application No. 62/186,989, filed on Jun. 30, 2015.

(51) Int. Cl. H04L 29/06

(52) U.S. Cl. CPC H04L 63/0236

(57) ABSTRACT

A computer-implemented method provides scalable access to resources in a firewall-protected network to a user or application outside the firewall-protected network. A connector application located inside the firewall and a conductor application located outside the firewall operate in conjunction to make such a firewall-protected resource or server available to an external client located outside the firewall. Alternatively, the connector application and the conductor application may operate in conjunction to enable a firewall-protected client to access an external server located outside the firewall.

### CROSS REFERENCE TO RELATED APPLICATIONS

This application claims priority under 35 U.S.C. §119(e) to U.S. Provisional Application No. 62/186,989, filed on Jun. 30, 2015, the entire contents of which are incorporated herein by reference thereto.

### BACKGROUND OF THE INVENTION

Field of the Invention

Embodiments of the present invention relate generally to computing systems and, more specifically, to a method for providing scalable access to firewall-protected resources.

Description of the Related Art

Typically, information networks are protected by a firewall or other network security system that prevents unauthorized access to and modification of network-accessible resources, such as network devices, data, and software applications. The firewall generally controls the incoming and outgoing network traffic based on an applied rule set, thereby establishing a barrier between a secure internal network and an external network that is not secure, such as the Internet. The rule set is usually configurable to allow outside access to network services and other resources in the protected network as desired. However, individual users of the network are often either not able to modify the firewall rule set or, in the case of an enterprise network, not allowed to modify the firewall rule set. Instead, a request for the desired modification to the rule set is made to a network administrator or information technology manager. Consequently, making a network resource, such as a database or software application, available to users outside the network can be a time-consuming and bureaucratic process for the individual user of a network. Accordingly, there is a need in the art for methods and systems that make firewall-protected resources available outside the firewall.

### SUMMARY OF THE INVENTION

One or more embodiments of the present invention set forth a computer-implemented method for providing scalable access to resources in a firewall-protected network to a user or application outside the firewall-protected network. A connector application running inside the firewall and a conductor application running outside the firewall operate in conjunction to make such a firewall-protected resource or server available to an external client located outside the firewall. Alternatively, the connector application and the conductor application may operate in conjunction to enable a firewall-protected client to access an external server located outside the firewall.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1F schematically illustrate a computer-implemented system for providing scalable access to firewall-protected resources, according to one embodiment of the present invention.

FIG. 2 schematically illustrates the computer-implemented system of FIG. 1 after an additional supplemental socket connection is established, according to one embodiment of the present invention.

FIG. 3 schematically illustrates a computer-implemented system that includes multiple connector applications, according to one embodiment of the present invention.

FIG. 4 schematically illustrates a computer-implemented system that includes multiple connector applications, according to another embodiment of the present invention.

FIG. 5 schematically illustrates a computer-implemented system that includes multiple target server applications connected to a single connector application, according to an embodiment of the present invention.

FIG. 6 is a block diagram of a computing device that may be employed to implement one or more embodiments of the present invention.

FIGS. 7A and 7B set forth a flowchart of method steps of a method performed by a computer-implemented system for providing scalable access to firewall-protected resources, according to one embodiment of the present invention.

FIG. 8 schematically illustrates a computer-implemented system for providing scalable access to resources located outside a firewall, according to one embodiment of the present invention.

FIG. 9 sets forth a flowchart of method steps of a method performed by a computer-implemented system for providing scalable access to resources located outside a firewall, according to one embodiment of the present invention.

FIG. 10 schematically illustrates an embodiment of a network packet encapsulated with additional metadata, according to an embodiment of the present invention.

For clarity, identical reference numbers have been used, where applicable, to designate identical elements that are common between figures. It is contemplated that features of one embodiment may be incorporated in other embodiments without further recitation.

### DETAILED DESCRIPTION

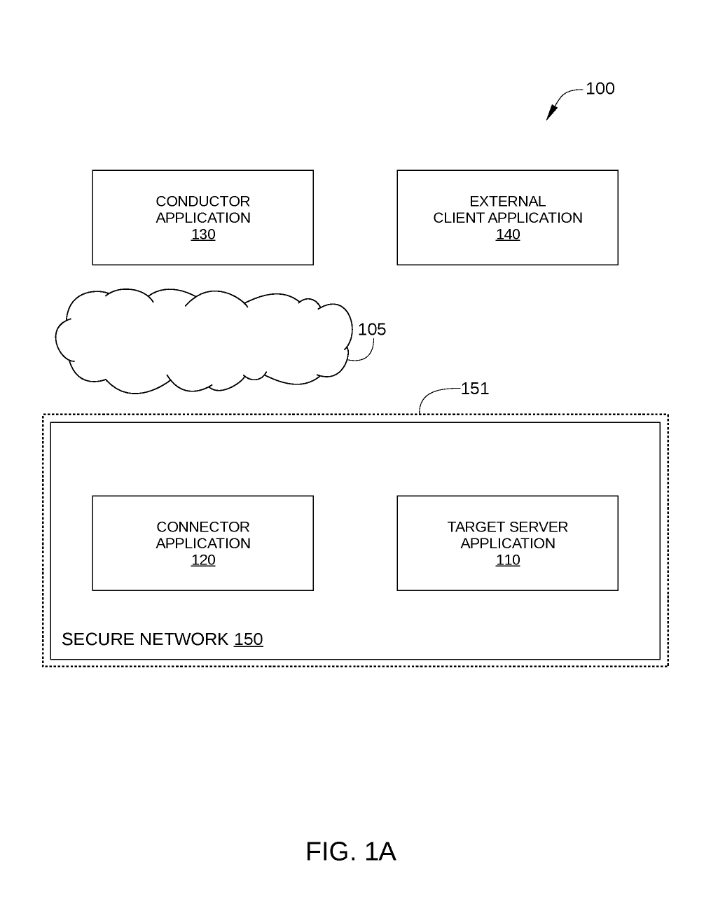

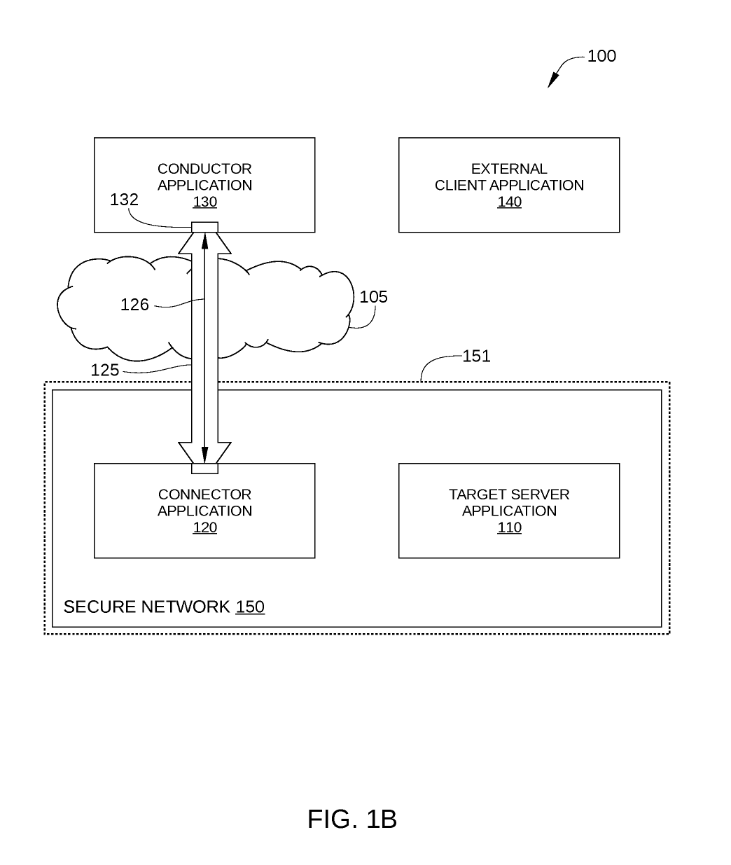

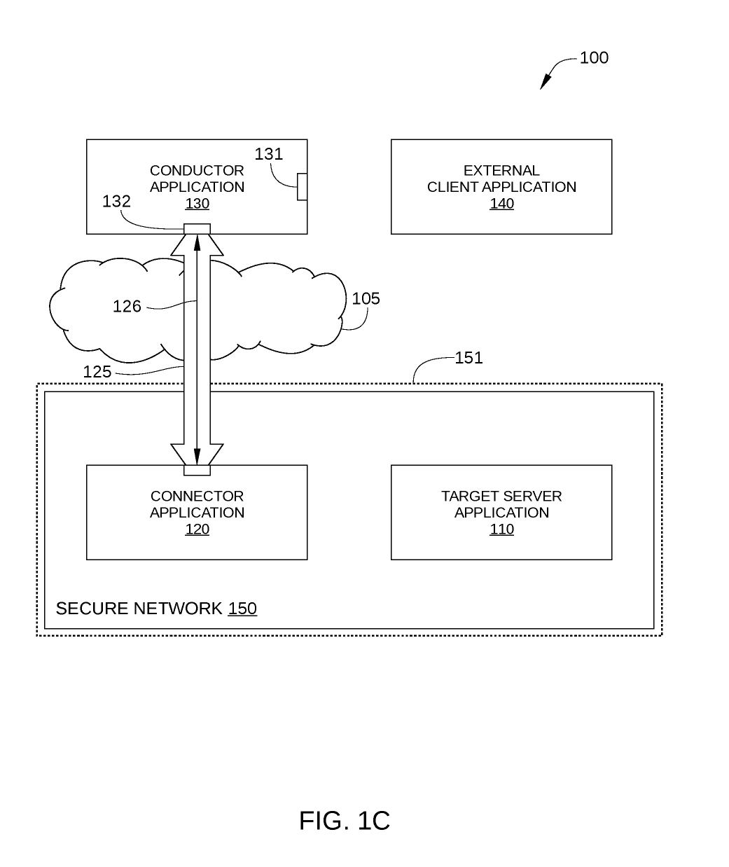

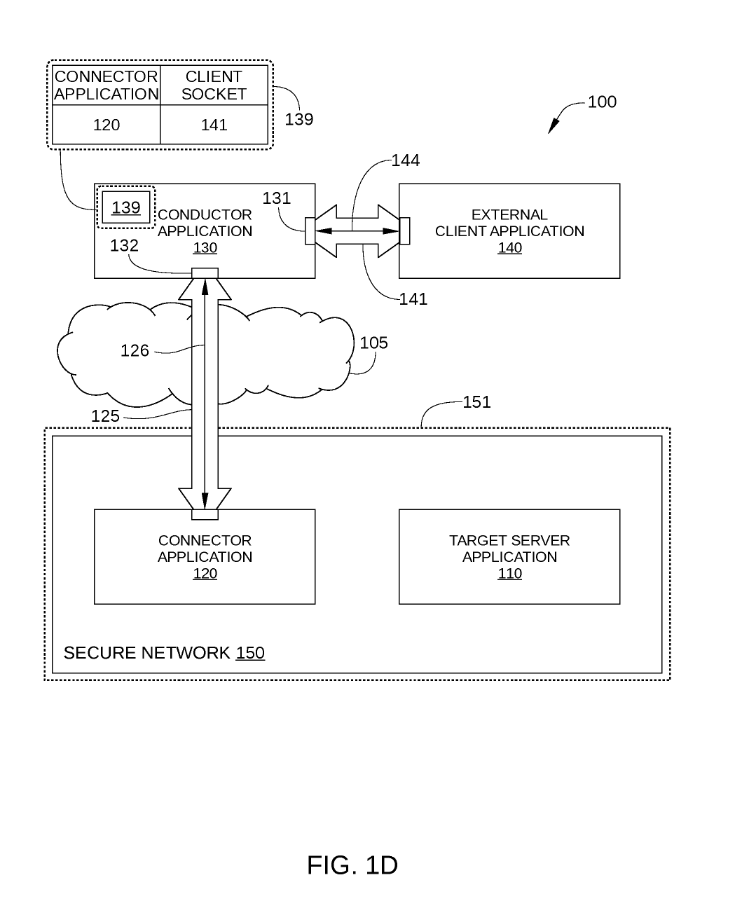

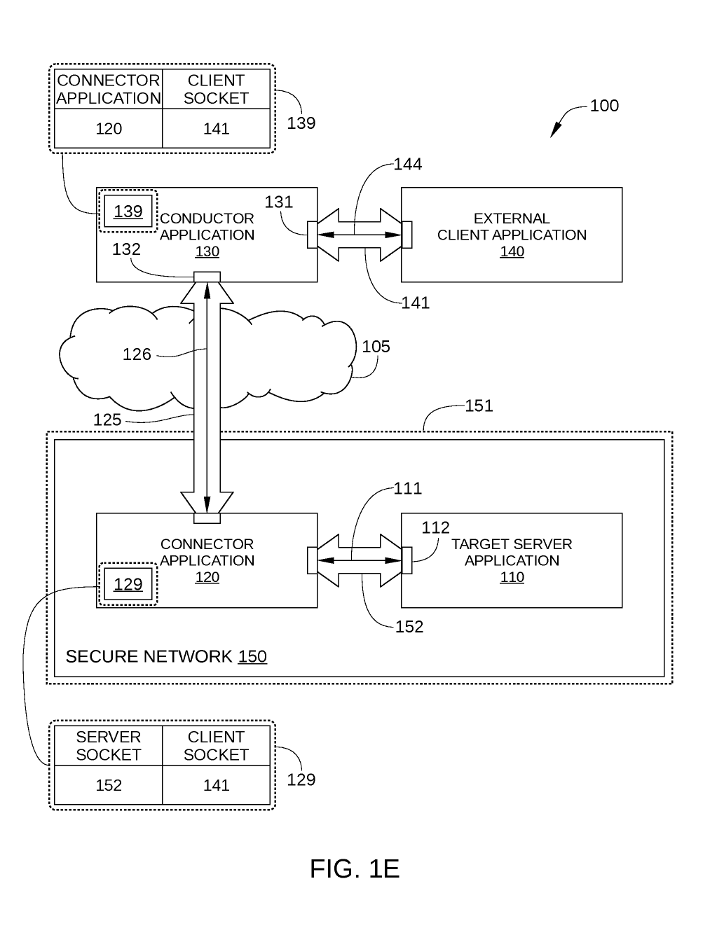

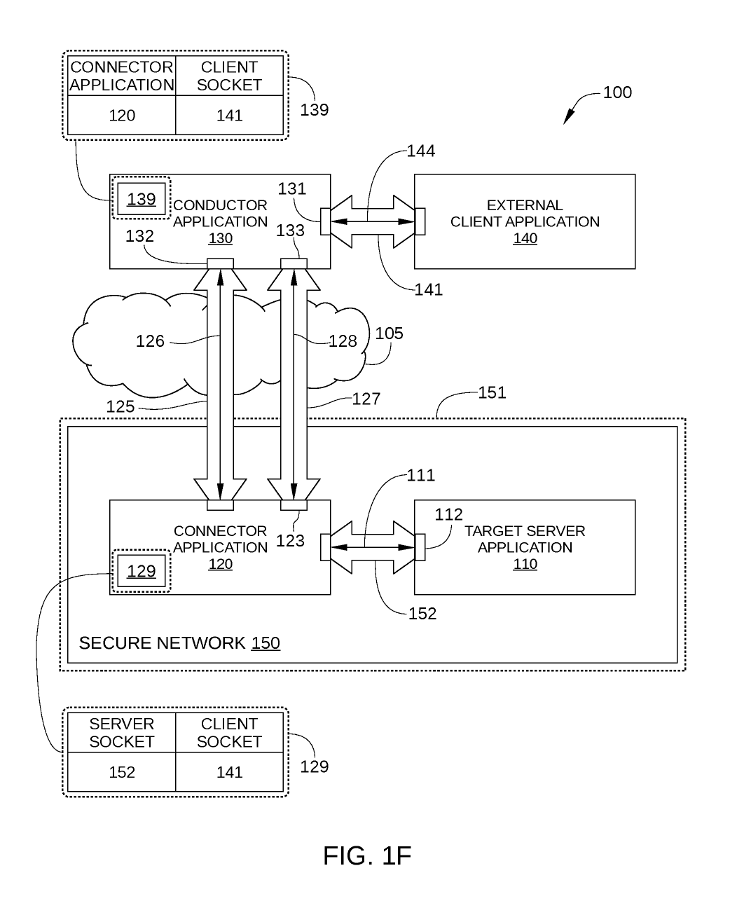

FIGS. 1A-1F schematically illustrate a computer-implemented system 100 for providing scalable access to firewall-protected resources, according to one embodiment of the present invention. Computer-implemented system 100 includes a target server application 110, a connector application 120, a conductor application 130, and an external client application 140. In the embodiment illustrated in FIG. 1A, target server application 110 and connector application 120 are disposed within a secure network 150, and conductor application 130 and external client application 140 are disposed outside of secure network 150.

Secure network 150 includes or is protected by a firewall 151, so that communication between target server application 110 and connector application 120 may be considered secure. However, data transmitted between connector application 120 and conductor application 130 are sent via an unsecured network 105, such as the Internet. Consequently, such communications generally only occur when permitted by firewall 151.

Secure network 150 may be any technically feasible type of communications network that allows data to be exchanged between target server application 110, connector application 120, and external entities or devices using any technically feasible wireless or wired physical transport technology. For example, secure network 150 may include a wide area network (WAN), a local area network (LAN), and/or a wireless (WiFi) network, among others. Similarly, unsecured network 105 may be any technically feasible type of communications network that allows data to be exchanged between connector application 120 and conductor application 130, and, in some embodiments, between conductor application 130 and external client application 140. For example, unsecured network 105 may include a WAN, a LAN, a wireless WiFi network, and/or the Internet, among others.

Firewall 151 may be any hardware, firmware, or software construct that implements security policies restricting access of external devices or applications, such as external client application 140, to devices or applications located inside secure network 150, such as target server application 110. Thus, firewall 151 may be any firewall or network address translation (NAT) device. For example, firewall 151 may be configured to prevent computing devices that are outside firewall 151 from connecting to any target device inside the firewall, regardless of whether the IP address of the target device is public, non-public, dynamic, or static. Similarly, when firewall 151 includes an NAT device, firewall 151 may provide dynamic or non-public IP addresses for devices inside the firewall, so that external processors or applications are unable to initiate communication with a target device having an IP address unknown to outside processors. Furthermore, firewall 151 may be configured to examine data packets to allow or prevent transport of packets utilizing certain network application protocols, e.g. HTTP, or to allow or prevent transport of packets originating from or directed to particular preconfigured IP addresses.

Target server application 110 may be any network-accessible resource, such as a network device, data source, and/or software application, capable of providing a data stream over a communication link to connector application 120. For example, target server application 110 may include a web-based application or any other software application or computing device configured to run over a Transmission Control Protocol (TCP) connection protocol, such as hypertext transfer protocol—(HTTP) or file transfer protocol—(FTP) based devices or applications. Target server application 110 may reside in a computing device, for example an instance of computing device 600 (described below), or across multiple computing devices. In some embodiments, target server application 110 may reside in the same computing device as connector application 120, while in other embodiments, target server application 110 may reside in a separate computing device from connector application 120. Data 111 (shown in FIGS. 1E and 1F) may be transferred between target server application 110 and connector application 120 via any technically feasible communication link, which in some embodiments may include a TCP socket connection.

Connector application 120 is a software application or other software construct configured to initiate a control socket (such as control socket 125 in FIG. 1B) with conductor application 130, where the control socket is a persistent communication connection, such as a TCP socket connection. In some embodiments, connector application 120 may be configured to initiate one or more additional socket connections between connector application 120 and conductor application 130, as described below in conjunction with FIG. 1F. Connector application 120 is also configured to receive data from conductor application 130 and, when these data include data that are part of a data stream between external client application 140 and target server application 110, send or route such data to target server application 110.

Connector application 120 resides within secure network 150, either on the same computing device as target server application 110 or on a separate computing device, for example on an instance of computing device 600 (described below). In some embodiments, connector application 120 is implemented as a user-level application that resides in a computing device, whereas in other embodiments connector application 120 may be implemented as an operating system module.

Conductor application 130 is a software application or other software construct configured to listen on a predetermined port, e.g., known port 132 (shown in FIG. 1B), to facilitate the establishment of a control socket with connector application 120 and to request additional socket connections between connector application 120 and conductor application 130. In addition, conductor application 130 is configured to transfer data between connector application 120 and one or more external client applications 140, as described below. As shown, conductor application 130 resides outside of secure network 150, either on the same computing device as external client application 140 or, more typically, on a separate computing device, for example on an instance of computing device 600. In some embodiments, conductor application 130 is implemented as a user-level application that resides in a computing device, whereas in other embodiments, conductor application 130 may be implemented as an operating system module. In some embodiments, conductor application 130 includes a mapping 139 that enables management of communications between conductor application 130 and connector application 120. Mapping 139 is described below in conjunction with FIG. 1D.

External client application 140 may be any network-accessible software application capable of accessing target server application 110 and providing a data stream over a TCP socket connection between external client application 140 and conductor application 130. For example, external client application 140 may be a web browser or any other software application or computing device configured to run over a TCP connection.

FIG. 1B schematically illustrates computer-implemented system 100 after connector application 120 initiates a control socket 125 between connector application 120 and conductor application 130. Control socket 125 is a persistent communication connection, such as a TCP socket connection, that is established between connector application 120 and conductor application 130. In some embodiments, connector application 120 may initiate control socket 125 with known port 132 associated with conductor application 130. In some embodiments, known port 132 includes a secure port to withstand “man-in-the-middle” and eavesdropping attacks, such as TCP port 443. In such embodiments, connector application 120 may be configured to initiate control socket 125 using an authentication protocol with conductor application 130 to authenticate control socket 125.

Control socket 125 enables data 126 to be transferred between connector application 120 and conductor application 130 without being stopped by firewall 151. For example, data 126 may include control data, such as data traffic associated with opening additional socket connections at connector application 120 and conductor application 130, or other communications between connector application 120 and conductor application 130. In some embodiments, data 126 my include client data being routed from external client application 140 to connector application 120 via conductor application 130 and/or server data being routed from target server application 110 to conductor application 130 via connector application 120. In other embodiments, control socket 125 is reserved for control data only, in which case data 126 does not include such client data or server data.

In some embodiments, connector application 120 initiates control socket 125 upon startup of connector application 120. In other embodiments, connector application 120 initiates control socket 125 in response to a request from target server application 110. For example, target server application 110 may make such a request when a user of target server application 110 provides an input indicating that target server application 110 be made available to one or more external client applications 140.

FIG. 1C schematically illustrates computer-implemented system 100 after conductor application 130 receives a request from connector application 120 to make an advertised port 131, which is outside secure network 150, available to any external client application 140. In response, conductor application 130 opens advertised port 131 as shown. Advertised port 131 is a TCP port associated with target server application 110.

FIG. 1D schematically illustrates computer-implemented system 100 after external client application 140 initiates a socket connection 141 between advertised port 131 and external client application 140. Because conductor application 130 is configured to route data traffic 144 received via socket connection 141 to connector application 120, external client application 140 does not require any modification to have the capability to access target server application 110. That is, external client application 140 may access target server application 110 via conductor application 130 in the same way that external client application 140 would access target server application 110 directly when target server application 110 is not protected by firewall 151. This is because conductor application 130 and connector application 120 are configured to route data received from external client application 140 to target server application 110 and vice-versa. Thus, external client application 140 may be any software application capable of providing a data stream over socket connection 141 to another application, since the routing of data between socket connection 141 and target server application 110 is transparent to external client application 140 and target server application 110.

As shown in FIG. 1D, after socket connection 141 between conductor application 130 and external client application 140 is established, conductor application 130 updates mapping 139 to associate (or map) socket connection 141 (the “client socket”) with the specific connector application that requested opening the advertised port 131 that is included in the socket connection 141. Thus, in the simple embodiment illustrated in FIG. 1D, because connector application 120 requested opening of advertised port 131, and because advertised port 131 is included in socket connection 141, conductor application 130 updates mapping 139 so that socket connection 141 is mapped to connector application 120. Mapping 139 may reside locally in the computing device on which conductor application 130 is running. Alternatively or additionally, mapping 139 may be stored remotely from the computing device on which conductor application 130 is running.

Conductor application 130 is configured to route a data packet received from socket connection 141 to connector application 120 and vice versa. For example, data packets received via socket connection 141 are routed by conductor application 130 to connector application 120, via control socket 125 or any other socket connection established between conductor application 130 and connector application 120. Similarly, data packets received from connector application 120, via control socket 125 or any other socket connection established between conductor application 130 and connector application 120, are routed by conductor application 130 to socket connection 141. Conductor application 130 performs such routing based on mapping 139, in embodiments in which a connection socket between connector application 120 and conductor application 130 is dedicated to data traffic to and from target server application 110. In other embodiments, in which data traffic to and from target server application 110 is routed between connector application 120 and conductor application 130 via any of multiple connection sockets, conductor application 130 performs such routing based on mapping 130 and on metadata included in a received data packet.

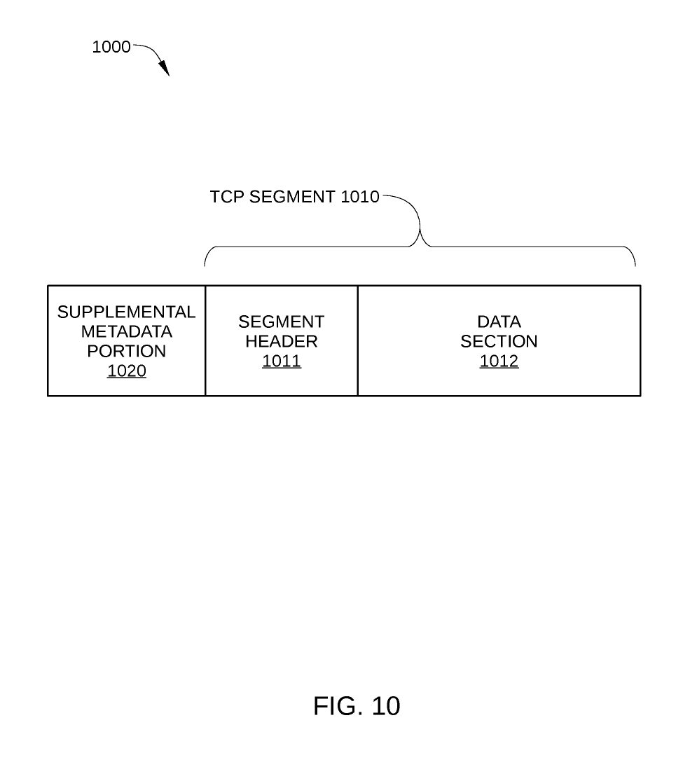

To enable routing of data packets from socket connection 141 to target server application 110, conductor application 130 may be configured to encapsulate or otherwise associate a data packet received via socket connection 141 with additional metadata, such as supplemental routing metadata. One example of a data packet encapsulated with additional metadata is described below in conjunction with FIG. 10. This additional metadata is supplemental to routing data typically included in a TCP data packet. For example, in some embodiments, the additional metadata indicates that the data packet so received is associated with socket connection 141, i.e., the metadata identifies the client socket associated with the data packet—in this case socket connection 141. In another example, the additional metadata indicates that the data packet so received is associated with the IP address and port associated with external client application socket connection 141, i.e., the metadata identifies the external client application associated with the data packet.

Thus, conductor application 130 is configured to receive a data packet via socket connection 141, encapsulate or otherwise associate the data packet with metadata (for example indicating that the client socket for the data packet is socket connection 141), and send the encapsulated or otherwise modified data packet to connector application 120 via any available socket connection. Consequently, connector application 120 receives a data packet from conductor application 130 that is associated with a particular client socket, e.g., socket connection 141, or external client application, e.g., external client application 140, and can route the data packet accordingly.

In an alternative embodiment, to enable routing of data packets from socket connection 141 to target server application 110, conductor application 130 may be configured to send a data packet received from socket connection 141 without the above-described metadata. Instead, conductor applicable 130 sends the received data packet to connector application 120 via a socket connection (not shown in FIG. 1D) between connector application 120 and conductor application 130 that is dedicated to data traffic originating at or being sent to target server application 110. In such embodiments, connector application 120 can correctly route the data packet to target server application 110, even when multiple target server applications are connected to connector application 120. For example, a mapping 129 (described below) in connector application 120 may associate target server application 110 with the socket connection between connector application 120 and conductor application 130 that is dedicated to data traffic originating at or being sent to target server application 110. Thus, in such embodiments, connector application 120 can, based on routing 129, route a data packet received via the dedicated socket connection to target server application 110.

To enable routing of data packets from target server application 110 to socket connection 141, conductor application 130 may be configured to unwrap or parse an encapsulated or otherwise modified data packet that is received from connector application 120. The encapsulated or otherwise modified data packet received from connector application 120 includes additional metadata similar to the additional metadata described above. For example, the additional metadata indicates a client socket that is associated with the encapsulated or otherwise modified data packet received from connector application 120. Thus, conductor application 130 is configured to receive an encapsulated or otherwise modified data packet from connector application 120, unwrap or parse the received packet, examine the additional metadata associated with the received packet to determine a client socket of the received packet, and, based on the client socket indicated by the additional metadata, send the unwrapped data packet to the client socket (in this case socket connection 141). Consequently, external client application 140 receives a conventional TCP data packet from conductor application 130 that has been routed from target server application 110 via connector application 120.

In an alternative embodiment, a socket connection (not shown in FIG. 1D) between connector application 120 and conductor application 130 is dedicated to data traffic originating at or being sent to target server application 110. In such embodiments, mapping 130 may be configured to associate target server application 110 with the socket connection dedicated to data traffic originating at or being sent to target server application 110. Thus, conductor application 130 can route data packets from connector application 120 to socket connection 141 based on mapping 139. In such embodiments, mapping 139 is modified to map client sockets (e.g., socket connection 141) to a specific socket connection established between connector application 120 and conductor application 130, such as a supplemental socket connection 127 (described below in conjunction with FIG. 1F).

FIG. 1E schematically illustrates computer-implemented system 100 after connector application 120 receives a request from conductor application 130 to initiate a socket connection 152 between target server application 110 and connector application 120. Such a request may be received via control socket 125. Generally, conductor application 130 sends the request to initiate socket connection 152 in response to an external client application 140 initiating socket connection 141 with conductor application 130, where the request typically includes the IP address and port associated with target server application 110. The request to initiate socket connection 152 may include metadata identifying the client socket that is associated with socket connection 152, in this case client connection 141. Alternatively or additionally, the request to initiate socket connection 152 may include metadata identifying the IP address and port associated with external client application 140, so that connector application 120 can map the IP address and port associated with external client application 140 to socket connection 152. Socket connection 152, which may be a TCP socket connection, may be defined by a port 112 associated with target server application 110. Connector application 120 may receive the appropriate connection information (e.g., the IP address of target server application 110 and the port number of port 112) for initiating socket connection 152 in the request from conductor application 130.

Once socket connection 152 is established between connector application 120 and target server application 110, connector application 120 is configured to update mapping 129 and, based on mapping 129, route data traffic 111 between conductor application 130 and target server application 110. Connector application 120 updates mapping 129 to associate (or map) socket connection 152 (the “server socket”) with the specific client socket included in the request from conductor application 130 to open the server socket. Thus, in the simple embodiment illustrated in FIG. 1E, because conductor application 130 requested initiation of socket connection 152, and because conductor application 130 included socket connection 141 in the request, connector application 120 updates mapping 129 so that socket connection 141 is mapped to socket connection 152. Mapping 129 may reside locally in the computing device on which connector application 120 is running. Alternatively or additionally, mapping 129 may be stored remotely from the computing device on which connector application 120 is running.

It is noted that mapping 129 can be configured in any technically feasible way to enable connector application 120 to appropriately route data from one or more target server applications 110 to one or more external client applications 140 via conductor application 130. Thus, mapping 129 may include the IP address and port number associated with each target server application connected to connector application 120 rather than the server socket associated with each target server application. Similarly, mapping 129 may include the IP address and port number associated with each external client application connected to conductor application 130 rather than the server socket associated with each external client application.

Connector application 120 is configured to route data packets received from socket connection 152 to conductor application 130 and vice versa. For example, data packets received via socket connection 152 are routed by connector application 120 to conductor application 130, via control socket 125 (or any other suitable socket connection established between conductor application 130 and connector application 120). Similarly, data packets received from conductor application 130, via control socket 125 (or any other socket connection established between conductor application 130 and connector application 120), are routed by connector application 120 to socket connection 152.

In some embodiments, to enable routing of data packets from socket connection 152 to external client application 140, connector application 120 is configured to encapsulate or otherwise associate a data packet received via socket connection 152 with additional metadata. Connector application 120 determines the additional metadata based on mapping 129. This additional metadata is supplemental to routing data typically included in a TCP data packet, and indicates that the data packet so received is associated with a particular client socket. Specifically, the additional metadata indicates that the encapsulated or otherwise modified data packet is associated with the client socket mapped to socket connection 152. In the simple example illustrated in FIG. 1E, the additional metadata indicates that the data packet received via socket connection 152 is associated with socket connection 141. Thus, connector application 120 is configured to receive a data packet via socket connection 152, encapsulate or otherwise associate the received data packet with metadata indicating that the data packet is associated with a specific client socket, and send the encapsulated or otherwise modified data packet to conductor application 130 via any available socket connection. Consequently, conductor application 130 receives an encapsulated or otherwise modified data packet from connector application 120 that includes metadata indicating that the received data packet is associated with a particular client socket, e.g., socket connection 141. In this way, conductor application 130 can correctly route the received data packet based on the additional metadata, as described above.

In alternative embodiments, in which a socket connection (not shown in FIG. 1E) between connector application 120 and conductor application 130 is dedicated to data traffic originating at or being sent to target server application 110, connector application 120 may be configured to route a data packet received from socket connection 152 to conductor application 130 without the above-described metadata. In such embodiments, mapping 129 maps each target server application (or associated socket connection) connected to connector application 120 to a specific dedicated socket connection between connector application 120 and conductor application 130. Thus, when connector application 120 receives a data packet from target server application 110, mapping 129 is configured to indicate via which socket connection to send the data packet to conductor application 130. Although the data packet is not encapsulated or otherwise associated with additional metadata, conductor application 130 can determine to which client socket to send the data packet based on mapping 139 and on the socket connection connector application 120 used to send the data packet.

To enable routing of data packets from conductor application 130 to socket connection 152, connector application 120 may be configured to unwrap or parse an encapsulated or otherwise modified data packet that is received from conductor application 130. The encapsulated or otherwise modified data packet received from connector 130 includes additional metadata that indicates a client socket that is associated with the encapsulated or otherwise modified data packet received from conductor application 130. Alternatively, the additional metadata may include the IP address and port number of external client application 140. In either case, connector application 120 is configured to receive an encapsulated or otherwise modified data packet from conductor application 130, unwrap or parse the received packet, examine the additional metadata associated with the received packet, and, based on mapping 129 and on the client socket or IP address and port number indicated by the additional metadata, send the unwrapped data packet to the server socket (in this case socket connection 152). Consequently, target server application 110 receives a conventional TCP data packet from connector application 120 that has been routed from external client application 140 via conductor application 130.

In alternative embodiments, in which a socket connection (not shown in FIG. 1E) between connector application 120 and conductor application 130 is dedicated to data traffic originating at or being sent to target server application 110, connector application 120 may be configured to route a data packet received from conductor application 130 to socket connection 152 without the above-described metadata. In such embodiments, mapping 129 maps each target server application (or associated socket connection) connected to connector application 120 to a specific dedicated socket connection between connector application 120 and conductor application 130. Thus, when connector application 120 receives a data packet from conductor application 130, mapping 129 is configured to indicate to which target server application to send the data packet (e.g., target server application 110). Although the data packet is not encapsulated or otherwise associated with additional metadata, connector application 120 can determine to which target server application 110 to send the data packet based on mapping 129 and on the socket connection conductor application 130 used to send the data packet.

In addition to establishing control socket 125 and routing data between conductor application 130 and target server application 110, connector application 120 may also be configured to initiate one or more supplemental socket connections with conductor application 130. FIG. 1F schematically illustrates computer-implemented system 100 after connector application 120 receives a request from conductor application 130 to initiate supplemental socket connection 127 between conductor application 130 and connector application 120. Such a request may be received via control socket 125.

Supplemental socket connections 127 are TCP connections between connector application 120 and conductor application 130, for example between a port 123 associated with connector application 120 and a port 133 associated with conductor application 130. In some embodiments, conductor application 130 provides connector application 120 with a port number for initiating supplemental socket connection 127 at the time of the request. The one or more supplemental socket connections 127 enable data 128 to be transferred between connector application 120 and conductor application 130 without being stopped by firewall 151. Data 128 may include data traffic between external client application 140 and target server application 110. In some embodiments, data 128 may be limited to only data traffic between external client application 140 and target server application 110, while data 126 may be limited to control data between connector application 120 and conductor application 130. In other embodiments, data 126 and data 128 may each include both control data and data traffic between external client application 140 and target server application 110.

In some embodiments, supplemental socket connections 127 enable scalable access by one or more external client applications 140 to firewall-protected resources within secure network 150, such as target server application 110. In some embodiments, connector application 120 is configured to initiate one or more supplemental socket connections 127 in response to a request, sent via data 126 and control socket 125, from conductor application 130. For example, when multiple external client applications 140 simultaneously attempt to access target server application 110, additional bandwidth between conductor application 130 and connector application 120 may facilitate such access for reduced latency, such as when the bandwidth of socket connections across firewall 151 are limited by hardware limitations associated with firewall 151 or by firewall rate limits.

In some embodiments, connector application 120 initiates a new supplemental socket connection 127 with conductor application 130 for each target server application connected to connector application 120. In such embodiments, each supplemental socket connection 127 may be reserved for data traffic originating at or being sent to a particular target server application 110. As described above, in such embodiments, data packets may be routed between external client application 140 and target server application 110 without being encapsulated with additional metadata. Even when multiple target server applications are connected to connector application 120 and/or multiple external client applications are connected to conductor application 130, data packets may be routed correctly without such additional metadata.

As shown in FIG. 1F, in some embodiments mapping 139 and mapping 129 are unaffected by the addition of one or more supplemental socket connections 127 between conductor application 130 and connector application 120. This is because in such embodiments mapping 129 and mapping 139 may not be based on specific socket connections between connector application 120 and conductor application 130, and any available routing between connector application 120 and conductor application 130 may be employed in computer-implemented system 100. Consequently, in embodiments in which multiple socket connections are extant between connector application 120 and conductor application 130, any such socket connection may be employed by conductor application 130 to satisfy the routing of data as indicated by mapping 139, and any such socket connection may be employed by connector application 120 to satisfy the routing of data as indicated by mapping 129. It is noted that in embodiments in which a supplemental socket connection 127 is associated with a single target server application 110, mapping 129 and mapping 139 are modified with the addition or removal of each supplemental socket connection.

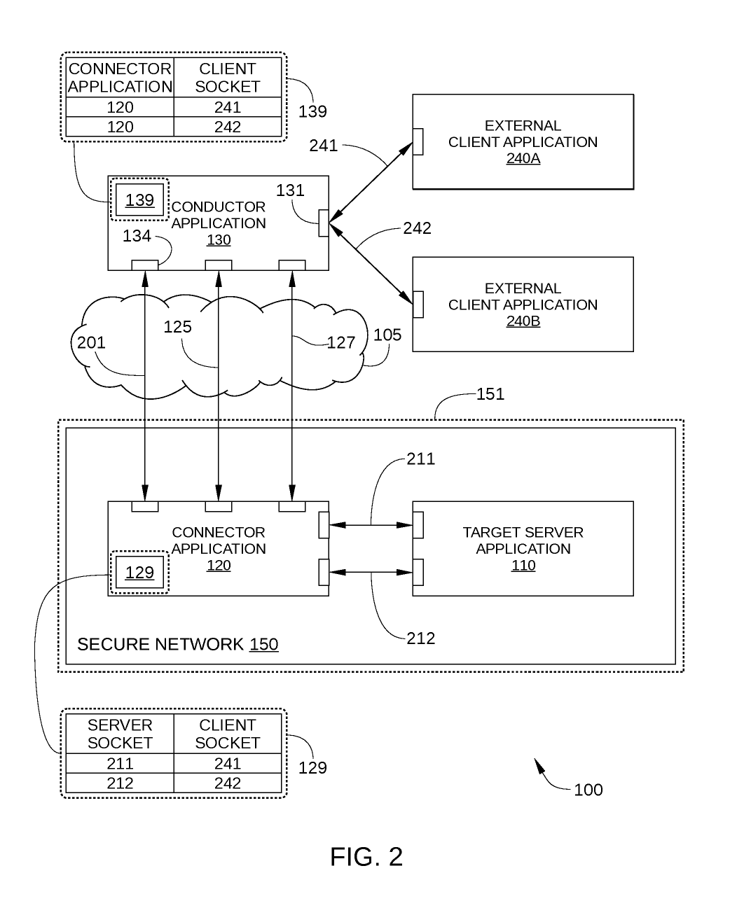

In the embodiment illustrated in FIGS. 1A-1F, only a single external client application 140 is depicted. However, in some embodiments, multiple external client applications may each initiate a TCP connection that, similar to socket connection 141, includes advertised port 131. Thus, in such embodiments, multiple external client applications may access target server application 110, either serially or in parallel. However, as additional data traffic between the multiple external client applications increases, the capacity of supplemental socket connection 127 and control socket 125 may be exceeded. In some embodiments, one or more additional socket connections may be established between connector application 120 and conductor application 130. One such embodiment is illustrated in FIG. 2.

FIG. 2 schematically illustrates computer-implemented system 100 after an additional supplemental socket connection 201 is established, according to one embodiment of the present invention. In addition, two external client applications 240A and 240B are connected to advertised port 131 via socket connections 241 and 242, respectively.

In the embodiment illustrated in FIG. 2, external client applications 240A and 240B have each initiated a socket connection with conductor application 130 to access target server application 110. When external client application 240A initiates socket connection 241, conductor application 130 sends a request to connector application 120 to initiate a socket connection 211 with target server application 110. Similarly, when external client application 240B initiates socket connection 242, conductor application 130 sends a request to connector application 120 to initiate a socket connection 212 with target server application 110. As shown, due to the presence of multiple external client applications accessing target server application 110, mapping 129 and mapping 139 are updated accordingly.

In the embodiment illustrated in FIG. 2, mapping 139 is updated with entries associating socket connection 241 and 242 with connector application 120, since connector application 120 is the connector application that connects target server application 110 with conductor application 130. Based on mapping 139, conductor application 130 can route data received via socket connection 241 or 242 to the appropriate connector application, in this case connector application 120. Similarly, mapping 129 is updated with entries associating socket connection 241 with socket connection 211 and socket connection 242 with socket connection 212, since these are the respective socket connections initiated by connector application 120 when external client applications 240A and 240B respectively initiated a socket connection with conductor application 130 to access target server application 110. Consequently, when connector application 120 receives a data packet from target server application 110 via either socket connection 211 or 212, connector application 120 can encapsulate the data packet with appropriate metadata (i.e., the appropriate client socket number) that enables conductor application 130 to correctly route the data packet to either socket connection 241 or 242. Further, when connector application 120 receives a data packet from conductor application 130 via any of socket connection 125 or supplemental socket connections 127 or 201, connector application 120 can route the data packet to the appropriate socket connection to target sever application 110 based on additional metadata included with the data packet by conductor application 130.

In embodiments in which a unique socket connection between connector application 120 and conductor application 130 is reserved for data traffic to and from each of external client applications 240A and 240B, mapping 129 and mapping 139 may be configured differently. For example, in one such embodiment, supplemental socket connection 127 may be reserved for data traffic between external client application 240A and target server application 110 and supplemental socket connection 201 may be reserved for data traffic between external client application 240B and target server application 110. In such an embodiment, mapping 129 may be configured to map server socket 211 to supplemental socket connection 127 and server socket 212 to supplemental socket connection 201. Furthermore, in such an embodiment, mapping 139 may be configured to map client socket 241 to supplemental socket connection 127 and client socket 242 to supplemental socket connection 201. Consequently, when connector application 120 sends a data packet from target server application 110 to conductor application 130, connector application 120 can indicate to which external client application the data packet should be routed without additional metadata. Specifically, connector application 120 routes the data packet to conductor application 130 via supplemental socket connection 127 to indicate that the data packet should be routed to external client application 240A, and via supplemental socket connection 201 to indicate that the data packet should be routed to external client application 240B. Based on mapping 139 and the socket connection used to send the data packet, conductor application 130 can then route the data packet to external client application 240A or 240B, as appropriate.

Supplemental socket connection 201 is a TCP connection that application 120 initiates with a port 134 that is associated with conductor application 130. Supplemental socket connection 201 enables more data to be transported between connection application 120 and conductor application 130, thereby reducing latency therebetween. In such embodiments, the functionality for determining whether supplemental socket connection(s) 201 should be added may reside partially or completely in connector application 120 and/or in conductor application 130. Such a determination may be made based on a data capacity or rate limit of the current supplemental socket connection 127, the current load of data traffic in the existing supplemental socket connection 127, limitations of any hardware associated with supplemental socket connection 127, and the like.

Supplemental socket connection 201 may be established in response to the determination that a data capacity of supplemental socket connection 127 has been exceeded, for example when multiple external client applications 240A and 240B simultaneously access target server application 110 via conductor application 130. As noted above, either connector application 120 or conductor application 130 may be configured to determine that establishment of additional supplemental socket connections 201 may be beneficial to data traffic between external client application(s) and target server application 110. Thus, connector application 120 either determines itself or is notified by conductor application 130, via data 126, that one or more supplemental socket connections 201 may be beneficial to performance. Connector application 120 then initiates supplemental socket connection 201 with port 134. More such TCP connections may be similarly established as data traffic increases between external client applications 240A and 240B and target server application 110.

In some embodiments, supplemental socket connection 201, as well as any other such supplemental socket connections established by connector application 120, may be established based on any other suitable criterion. For example, connector application 120 may establish a supplemental socket connection 201 for a predetermined number of advertised ports 131 opened by conductor application 130. Alternatively or additionally, connector application 120 may establish a supplemental socket connection 201 for a predetermined number of target server applications 110 connected to conductor application 130 via connector application. In some embodiments, the predetermined number of dedicated client ports 131 and/or the predetermined number of target server applications 110 may be selected based on a network policy of firewall 151 and/or on hardware limitations of the host associated with connector application 120 or conductor application 130. In some embodiments and as described above, one supplemental socket connection 201 may be established for each external client application (e.g., external client applications 240A and 240B) that initiates a socket connection to an advertised port associated with conductor application 130 (e.g., advertised port 131). In such embodiments, each such supplemental socket connection 201 may be reserved for data traffic to and from a specific external client application.

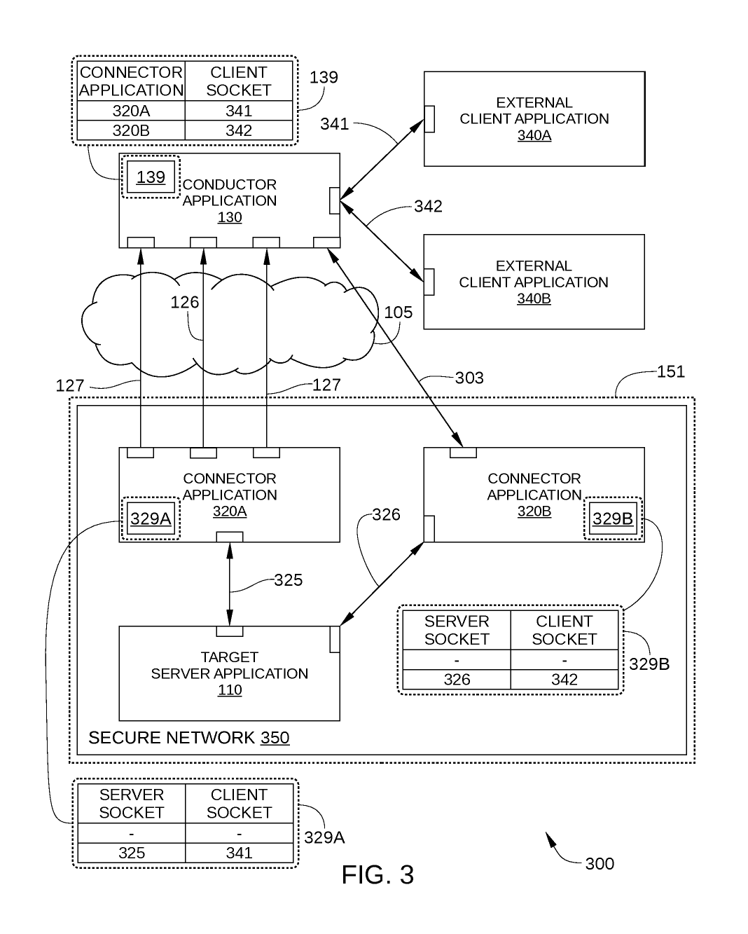

In some embodiments, multiple connector applications may be implemented in a secure network to improve the functionality and/or performance of communications between external client application(s) and a target server application. One such embodiment is illustrated in FIG. 3. FIG. 3 schematically illustrates a computer-implemented system 300 that includes multiple connector applications 320A and 320B, according to one embodiment of the present invention. With the exception of connector applications 320A and 320B, computer-implemented system 300 may be substantially similar in configuration and operation to computer-implemented system 100 in FIG. 1. In addition, each of connector applications 320A and 320B may be substantially similar in configuration and operation to connector application 120 in FIG. 1.

As shown, connector applications 320A and 320B are disposed in a secure network 350, and each provides at least one TCP connection to target server application 110. In the embodiment illustrated in FIG. 3, connector application 320A provides a socket connection 325 to target server application 110, so that data can be transported between connector application 320A and target server application 110. In this way, a data stream is enabled between external client application 340A and target server application 110. Similarly, connector application 320B provides a socket connection 326 to target server application 110 so that data can be transported between connector application 320B and target server application 110. Connector application 320B also provides one or more socket connections 303 between conductor application 130 and connector application 320B. In this way, a data stream is enabled between external client application 340B and target server application 110. Moreover, connection applications 320A and 320B may each establish one or more supplemental socket connections with conductor application 130, further improving access to target server 110 by external client servers 340A and 340B.

In the embodiment illustrated in FIG. 3, mapping 329A and 329B each map client sockets to a specific server socket, and mapping 139 maps client sockets to a specific connection application. However, any other mapping scheme may be implemented in mapping 329A, 329B, and 139 that enables routing of data packets between target server application 110 and external client applications 340A and 340B as described herein.

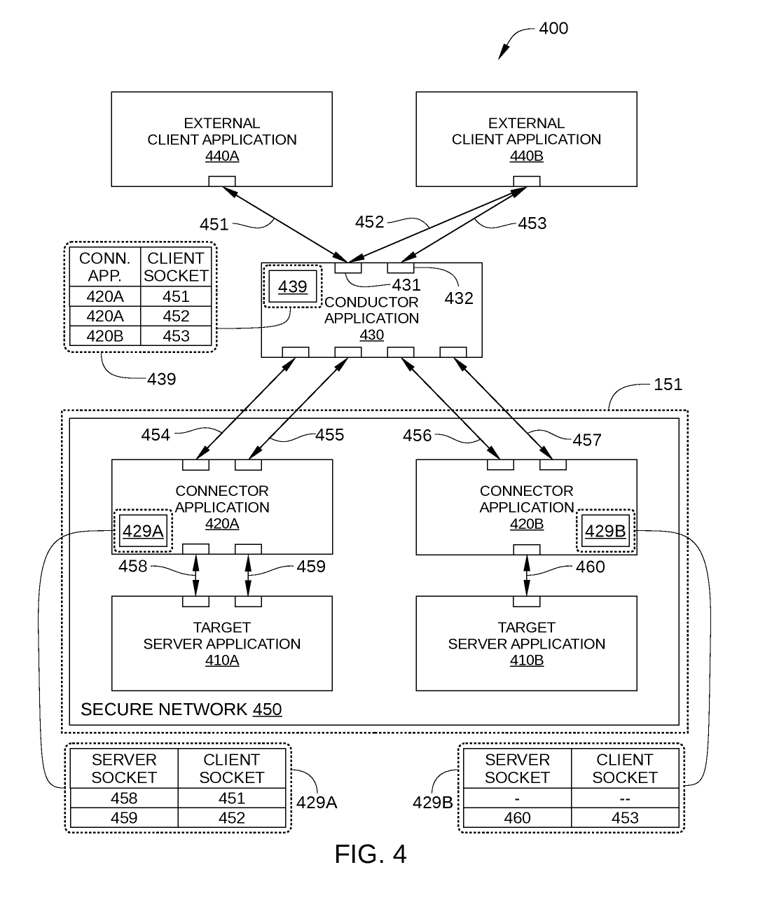

In some embodiments, access to multiple target servers in a secure network by external client server(s) may be improved by implementing multiple connector applications within the secure network, where each connector application provides access to different target server applications than each of the other connector applications. One such embodiment is illustrated in FIG. 4. FIG. 4 schematically illustrates a computer-implemented system 400 that includes multiple connector applications 420A and 420B, according to an embodiment of the present invention. With the exception of connector applications 420A and 420B and target server applications 410A and 410B, computer-implemented system 400 may be substantially similar in configuration and operation to computer-implemented system 300 in FIG. 3. Each of connector applications 420A and 420B may be substantially similar in configuration and operation to connector application 120 in FIG. 1, except for the differences described below. Similarly, each of target server applications 410A and 410B may be substantially similar in configuration and operation to target server application 110 in FIG. 1, except for the differences described below.

As shown, connector applications 420A and 420B and target server applications 410A and 410B are disposed in a secure network 450, and external client applications 440A and 440B and conductor application 430 are disposed outside secure network 450. External client application 440A is connected to conductor application 430 via a socket connection 451, while external client application 440B is connected to conductor application 430 via a socket connection 452 and a socket connection 453. In addition, conductor application 430 is connected to connector application 420A via socket connections 454 and 455, and to connector application 420B via socket connections 456 and 457.

Socket connections 451 and 452 include advertised port 431, which is opened by conductor application 430 in response to a request by conductor application 420A. Therefore, mapping 439 indicates that socket connections 451 and 452 are mapped to connector application 420A. Similarly, socket connection 453 includes advertised port 432, which is opened by conductor application 430 in response to a request by conductor application 420B. Therefore, mapping 439 indicates that socket connection 453 is mapped to connector application 420B. Mapping 429A indicates that socket connection 458 (a server socket) is mapped to socket connection 451, and socket connection 459 (another server socket) is mapped to socket connection 452. Mapping 429B indicates that socket connection 460 (another server socket) is mapped to socket connection 453.

In operation, external client application 440A accesses target server application 410A, and external client application 440B accesses target server applications 410A and 410B according to mappings 429A, 429B, and 439. Therefore, data packets from external client application 440A are routed to target server application 410A via socket connection 451, connector application 420A, and socket connection 458; data packets from external client application 440B are routed to target server application 410A via socket connection 452, connector application 420A, and socket connection 459; and data packets from external client application 440B are routed to target server application 4108 via socket connection 453, connector application 420B and socket connection 460.

The implementation of multiple connector applications in secure network 450 can significantly improve performance and functionality of computer-implemented system 400. For example, when connector applications 420A and 420B each run on a different computing device, data capacity for accessing target server applications 410A and 410B may be increased proportionate to the data processing capacity of these multiple computing devices. Consequently, access to a larger number of target server applications or a larger number of accesses to a single target server application is enabled.

For clarity, in FIG. 4 connector applications 420A and 420B are each illustrated connected to a single target server application. In practice, connector applications 420A and 420B may each be connected to multiple target server applications. For each such target server application, the associated connector application initiates a socket connection between the target server application and the associated connector application, and either mapping 429A or 429B is updated accordingly. It is noted that any other mapping scheme may be implemented for mappings 439, 429A and 429B that enables the above-described routing of data packets.

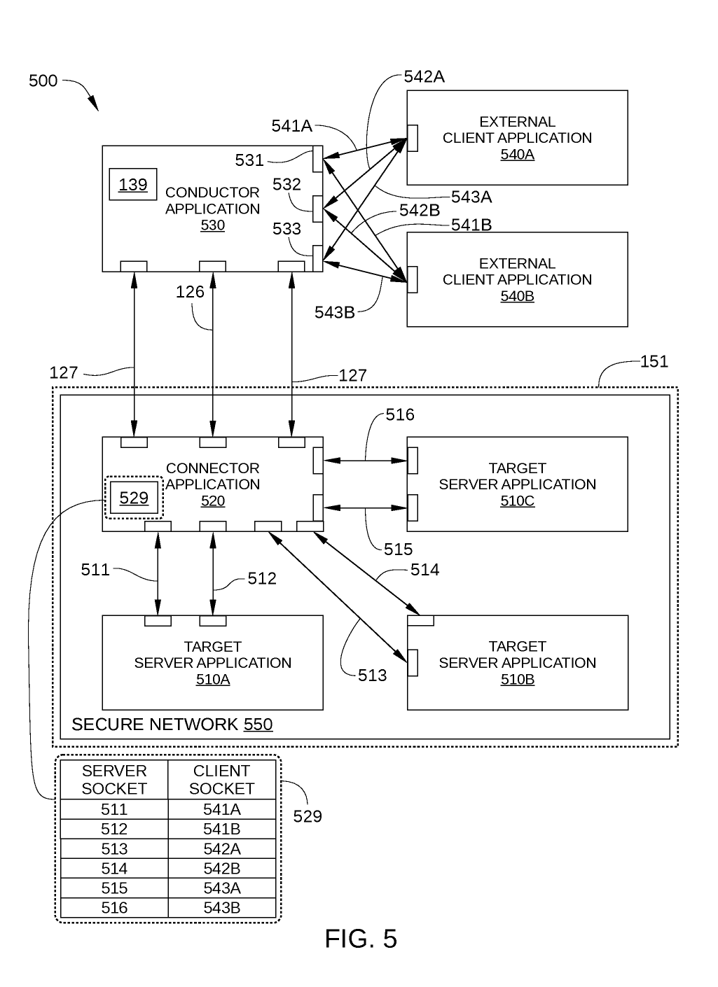

FIG. 5 schematically illustrates a computer-implemented system 500 that includes multiple target server applications connected to a single connector application 520, according to an embodiment of the present invention. Computer-implemented system 500 may be substantially similar in configuration and operation to computer-implemented system 100 in FIG. 1, except for the differences described below.

As shown, connector application 520 and target server applications 510A, 510B, and 510C are disposed in a secure network 550, while external client application 540A, external client application 540B, and conductor application 530 are disposed outside secure network 550. External client application 540A is connected to conductor application 530 via three socket connections 541A, 542A, and 543A, while external client application 540B is connected to conductor application 530 via three different socket connections 541B, 542B, and 543B. Connector application 520 is connected to target server application 510A via socket connections 511 and 512, to target server application 510B via socket connections 513 and 514, and to target server application 510C via socket connections 515 and 516.

Conductor application 530 is connected to connector application 520 via control socket 126 and supplemental socket connections 127, and includes a first advertised port 531, a second advertised port 532, and a third advertised port 533. First advertised port 531 is opened by conductor application 530 in response to connector application 520 requesting an advertised port to be opened for access to target server application 510A. Consequently, when external client application 540A initiates socket connection 541A (which includes first advertised port 531), connector application 520 responds by initiating a socket connection 511 to target server application 510A, and updating a mapping 529 to indicate that socket connection 541A is associated with socket connection 511. Similarly, second advertised port 532 is opened by conductor application 530 in response to connector application 520 requesting an advertised port to be opened for access to target server application 510B, and third advertised port 533 is opened by conductor application 530 in response to connector application 520 requesting an advertised port to be opened for access to target server application 510C.

As shown, external client application 540A also initiates socket connection 542A that includes second advertised port 532 and socket connection 543A that includes third advertised port 533, and connector application 520 responds by initiating socket connection 513 and 515 and updating mapping 529 accordingly. A similar process takes place with respect to external client application 540B, thereby populating mapping 529 as shown with respect to socket connections 541B, 542B, and 543B. Consequently, even though multiple external client applications are accessing multiple target server applications connected to connector application 520, connector application 520 and conductor application 530 can route data between the external client applications and the appropriate target client applications based on mapping 529 and 139.

It is noted that any other mapping scheme may be implemented for mappings 139 and 539 that enables the above-described routing of data packets in computer-implemented system 500. For example, in some embodiments, one supplemental socket connection 127 may be initiated and reserved for data traffic originating at or being sent to a particular target server application. In such embodiments, mappings 139 and 539 may be configured to map each reserved supplemental socket connection 127 to a corresponding client socket or server socket, as described above in conjunction with FIG. 2.

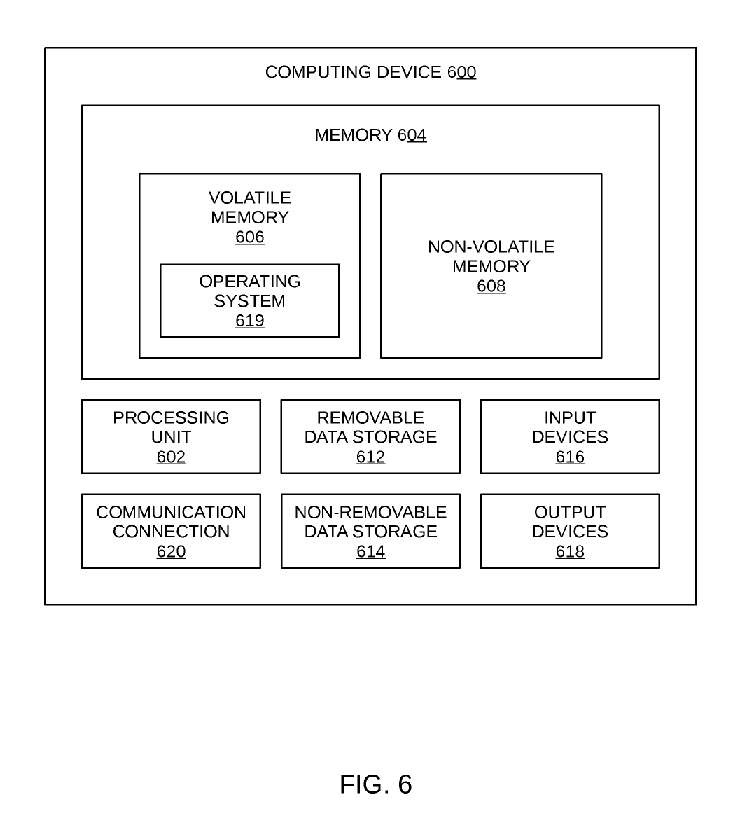

FIG. 6 is a block diagram of a computing device 600 that may be employed to implement one or more embodiments of the invention. Specifically, computing device 600 is configured to run any of the herein described target server applications, connector applications, conductor applications, and/or external client server applications, according to one embodiment of the invention. Computing device 600 includes a processing unit 602, memory 604, removable data storage 612, and non-removable data storage 614. Memory 604 may include volatile memory 606 and/or non-volatile memory 608, either of which may contain some or all of an operating system 619, and any of the herein described target server applications, connector applications, conductor applications, and/or external client server applications. Removable data storage 612 and non-removable data storage 614 may include random access memory (RAM), read only memory (ROM), erasable programmable read-only memory (EPROM) and/or electrically erasable programmable read-only memory (EEPROM), flash memory or other memory technologies, compact disc read-only memory (CD ROM), digital versatile disks (DVD) or other optical disk storage, magnetic cassettes, magnetic tape, magnetic disk storage or other magnetic storage devices, or any other medium capable of storing computer-readable instructions. Computing device 600 may further include input devices 616, output devices 618, and a communication connection 620. Input devices 616 may include one or more of a keyboard, a mouse, or other selection device, and output devices 618 include a suitable display device. Communication connection 620 may be configured to connect to a local area network (LAN), a wide area network (WAN), or other networks. Alternatively, computing device 600 may not physically include one or more of volatile memory 606, non-volatile memory 608, removable data storage 612, non-removable data storage 614, and/or output devices 618, and instead may have access to a computing environment that includes such devices.

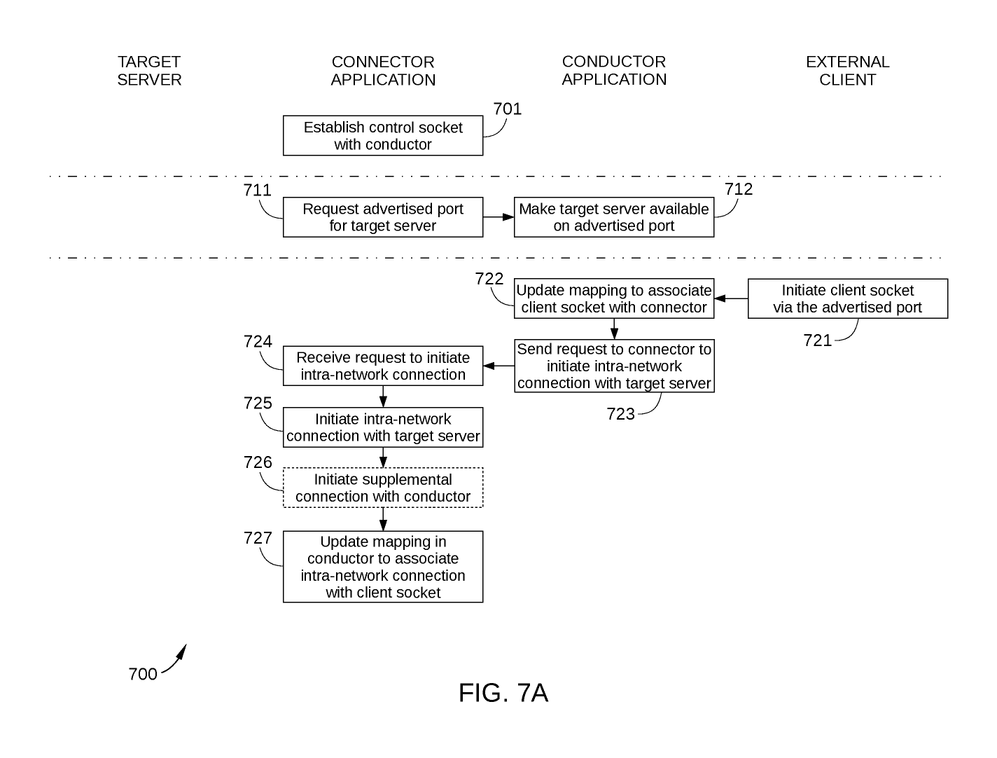

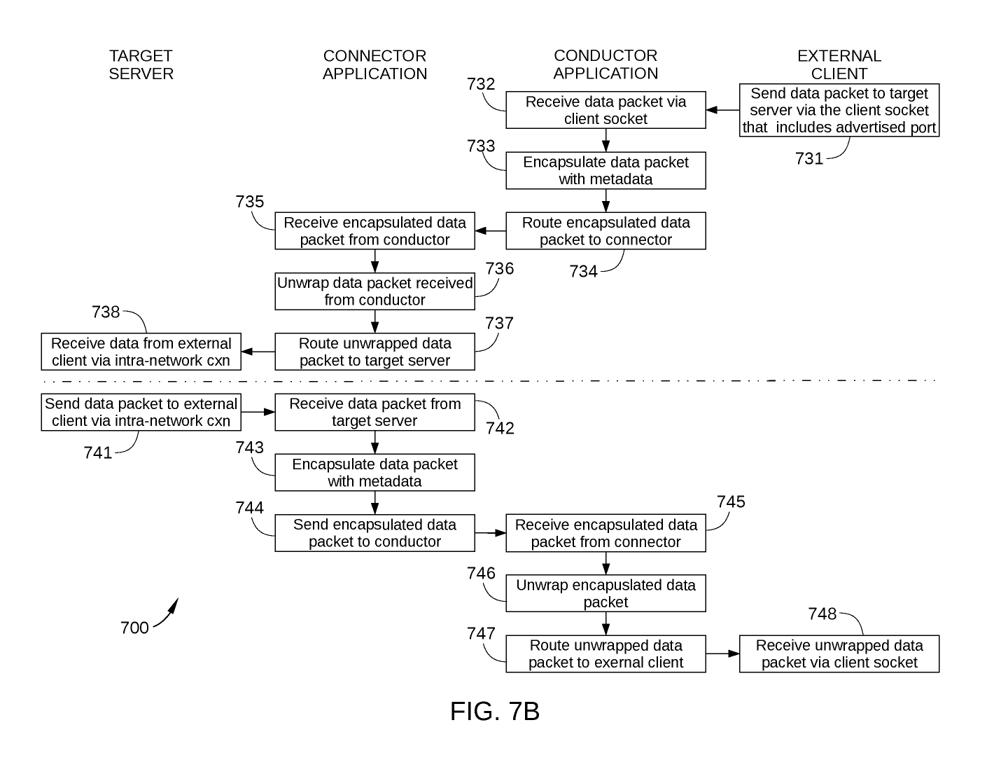

FIGS. 7A and 7B set forth a flowchart of method steps of a method 700 performed by a computer-implemented system for providing scalable access to firewall-protected resources, according to one embodiment of the present invention. Although the method steps are described in conjunction with computer-implemented system 100 of FIG. 1, persons skilled in the art will understand that any computing device or system of computing devices configured to perform the method steps is within the scope of the invention. Step 701 describes a startup phase, in which connector application 120 is first started up. Steps 711-712 describe an initiation phase, in which target server application 110 is made available to applications and/or devices outside firewall 151 via advertised port 131. Steps 721-728 describe a connection phase, in which a connection between a particular external client application 140 and target server application 110 is instantiated. In steps 731-738, shown in FIG. 7B, data traffic is sent from external client application 140 to target server application 110. In step 741-748, data traffic is sent from target server application 110 to external client application 140.

As shown in FIG. 7A, method 700 begins at step 701, where connector application 120 receives a start command and initiates a control socket 125, which is a persistent connection, with conductor application 130. The start command may be received from a user of target server application 110, for example when connector application 120 and target server application 110 run on the same computing device or when connector application 120 runs on a separate computing device. Alternatively, the start command may be generated remotely from the computing device on which target server application 110 is running.

In step 711, connector application 120 sends a request for opening advertised port 131 for target server application 110 to conductor application 130 via control socket 125. Advertised port 131 makes target server application 110 available to client applications outside secure network 150. In some embodiments, connector application 120 sends the request in response to a user input. Alternatively or additionally, connector application 120 may send the request in response to a request received from target server application 110, for example in embodiments in which target server application 110 is configured to interact with connector application 120. In step 712, conductor application 130 receives the request for advertised port 131, and opens advertised port 131. In some embodiments, connector application 120 may publish the association between target server application 110 and advertised port 131, such as on a web site, etc. In this way, an external client application 140 can initiate a socket connection with advertised port 131, instead of to target server application 110 directly. Conductor application 130 then listens on advertised port 131.

In step 721, in order to access target server application 110 and instantiate data flow thereto, external client application 140 initiates a socket connection 141 with conductor application 130 at advertised port 131. For example, the IP address and port number of advertised port 131 may be a configuration input made by the user of external client application 140 when attempting to access target server application 110. In step 722, in response to the socket connection 141 being initiated, conductor application 130 updates mapping 139 to associate socket connection 141 with connector application 120, i.e., the connector application that requested advertised port 131 to be opened. Alternatively, conductor application 130 updates mapping 130 to associate socket connection 141 or external client application 140 with a particular supplemental socket connection 127.

In step 723, conductor application 130 sends a request to connector application 120, via control socket 125, to initiate an intra-network connection with target server application 110. The request to connector application 120 may include information indicating that socket connection 141 should be mapped to the intra-network connection being requested and, in some embodiments, address information associated with external client application 140, such as and IP address and port number. In some embodiments, conductor application 130 may also send a request to connector application 120, via control socket 125, to initiate one or more supplemental socket connections 127 between connector application 120 and conductor application 130. As noted, in some embodiments, the supplemental socket connection 127 may be reserved for only data traffic to and from external client application 140.

In step 724, connector application 120 receives the request to initiate an intra-network connection to target server application 110, e.g., socket connection 152, and, in some embodiments, one or more supplemental socket connections 127. In step 725, connector application 120 initiates an intra-network connection with target server application 110, such as socket connection 152.

In optional step 726, connector application 120 initiates at least one supplemental socket connection 127 between connector application 120 and conductor application 130. In some embodiments, multiple supplemental socket connections 127 may be established in step 726, depending on the configuration of firewall 151, connector application 120, conductor application 130, and hardware associated therewith. Furthermore, in some embodiments, additional supplemental socket connections 127 may be established subsequently by connector application 120 in response to changes in data traffic between external client application 140 and target server application 110. Alternatively, a single supplemental socket connection 127 may be initiated in step 726 that is reserved for data traffic between external client application 140 and target server application 110.

In step 727, connector application 120 updates mapping 129 to facilitate routing of packets between target server application 110 and target server application 110. For example, connector application 120 may update mapping 120 to associate the intra-network socket, i.e., socket connection 152, with the client socket, i.e., socket connection 141. In this way, a communication connection between a particular external client application 140 and target server application 140 is instantiated without directly connecting across firewall 151.

In step 731, shown in FIG. 7B, external client application 140 sends a data packet to target server application 110 via a client socket that includes advertised port 131 (i.e., socket connection 141). The data packet may be configured as a standard TCP packet. In step 732, conductor application 130 receives the data packet from external client application 140, via socket connection 141.

In step 733, conductor application 130 determines through which client socket the data packet is received in step 732, and, in some embodiments, encapsulates the data packet with additional metadata associating the data packet with the socket connection so determined. The additional metadata may include any identifying information that enables routing of data packets from external client application 140 to target server application 110. For example, in some embodiments, the additional metadata may include information indicating socket connection 141 or information indicating external client application 140. In such embodiments, connector application 120 can subsequently determine where to route the data packet based on this additional metadata and mapping 129. Alternatively, when a supplemental socket connection 127 is associated with target server application 110, conductor application 130 does not encapsulate the data packet with additional metadata, since mapping 139 may be based on supplemental socket connections 127.

In step 734, based on mapping 139, conductor application 130 routes the encapsulated data packet to connector application 120 via control socket 125 or any of the one or more supplemental socket connections 127 established previously, or via a specific supplemental socket connection 127 associated with target server application 110. In embodiments in which the data packet is not encapsulated, conductor application 130 routes the data packet to connector application 120 via the specific supplemental socket connection 127 that is reserved for data traffic between external client application 140 and target server application 110. In such embodiments, mapping 139 may be configured to map supplemental socket connections 127 to particular client sockets.

In step 735, connector application 120 receives the data packet from conductor application 130. In some embodiments the data packet is encapsulated, and in other embodiments, the data packet is not encapsulated, depending on the configuration of supplemental socket connections 127 and mappings 129 and 139.

In step 736, connector application 120 unwraps the data packet if encapsulated, and determines to which intra-network connection coupled to conductor application 130 the unwrapped data packet should be routed. It is noted that connector application 120 may have established a plurality of intra-network connections associated with one or more target server applications other than target server application 110. Each of these target server applications associated with connector application 120 is connected thereto by a unique intra-network connection, e.g., socket connection 152. Therefore, connector application 120 may determine to which intra-network connection the unwrapped data packet should be routed based on mapping 129 and the metadata included in the encapsulated data packet. This is because mapping 129 maps each of the plurality of internal connections to a particular client socket of conductor application 130, and the metadata encapsulated with the encapsulated data packet includes an identifier associating the data packet with the client socket by which conductor application 130 originally received the data packet. Thus, based on the metadata and mapping 129, connector application 120 can correctly route the unwrapped data packet to target server application 110. Alternatively, in step 736, connector application 120 may determine to which intra-network connection the unwrapped data packet should be routed based on mapping 129 and the supplemental socket connection 127 from which the data packet was received.

In step 737, connector application 120 routes the unwrapped data packet to target server application 110 via the appropriate intra-network connection, e.g., socket connection 152. In step 738, target server application 110 receives the unwrapped data packet from connector application 120. In this way, a data packet is sent from external client application 140 to target server application 110 via conductor application 130 and connector application 120. Consequently, modifications of the rule set for firewall 151 are not needed.

In step 741, target server application 110 sends a data packet to external client application 140 via connector application 120 and socket connection 152. The data packet may be configured as a standard TCP packet. In step 742, connector application 120 receives the data packet via socket connection 152.

In step 743, connector application 120 encapsulates the data packet with additional metadata associating the data packet with a particular client socket of conductor application 130 or with external client application 140. Specifically, the metadata may include information indicating the client socket that corresponds to the external client application 140 that is associated with socket connection 152, as indicated by mapping 129. Alternatively or additionally, the metadata may include any other identifying information indicating the client socket or external client application that is associated with target server application 110. The metadata may be determined based on mapping 129. In alternative embodiments, in which a specific supplemental socket connection 127 is reserved for data traffic between external client application 140 and target server application 110, the data packet is not encapsulated

In step 744, connector application 120 routes the encapsulated data packet to conductor application 130 via control socket 125 or any supplemental socket connections 127 currently established between connector application 120 and conductor application 130. In embodiments in which the data packet is not encapsulated, connector application 120 routes the data packet to conductor application 130 via the specific supplemental socket connection 127 that is reserved for data traffic between external client application 140 and target server application 110.

In step 745, conductor application 130 receives the encapsulated data packet from connector application 120 via control socket 125 or via any supplemental socket connections 127. In embodiments in which control socket 125 is reserved for control data, conductor application 130 receives the encapsulated data packet from connector application 120 via a supplemental socket connection 127. In embodiments in which the data packet is not encapsulated with additional metadata, conductor application 130 receives the data packet via the specific supplemental socket connection 127 reserved for data traffic between external client application 140 and target server application 110.

In step 746, conductor application 130 unwraps the encapsulated data packet, and determines to which client socket connected to conductor application 130 the unwrapped data packet should be routed. Conductor application 130 may make this determination based on mapping 139 and the metadata included in the encapsulated data packet, such as an identifier associating the data packet with a particular client socket. Thus, conductor application 130 can correctly route the unwrapped data packet to the appropriate client socket, e.g., socket connection 141, and thereby to external client application 140. In embodiments in which the data packet is not encapsulated with additional metadata, conductor application 130 determines to which client socket the data packet should be routed based on the specific supplemental socket connection 127 by which the data packet was received. In such embodiments, mapping 139 may be configured to enable this determination.

In step 747, conductor application 130 routes the unwrapped data packet to external client application 140 via socket connection 141. In step 748, external client application 140 receives the unwrapped data packet from conductor application 130. In this way, a data packet is sent from target server application 110 to external client application 140 via connector application 120 and conductor application 130.

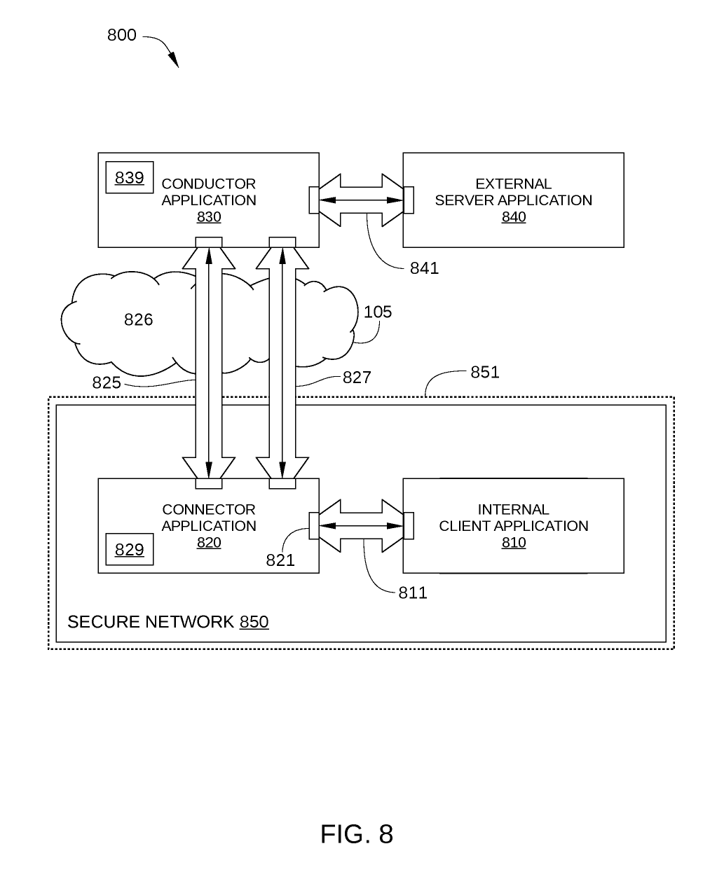

Generally, firewalls and similar devices allow devices or applications protected by the firewall to initiate a socket connection outside the firewall. However, in some situations, initiating a socket connection outside a firewall may be restricted, for example in an enterprise application. In some embodiments, scalable access to resources outside a firewall are provided to a client application that is running within a firewall via a conductor application disposed outside the firewall and a connector application disposed within the firewall. One such embodiment is illustrated in FIG. 8.

FIG. 8 schematically illustrates a computer-implemented system 800 for providing scalable access to resources located outside a firewall 851, according to one embodiment of the present invention. Computer-implemented system 800 includes an internal client application 810, a connector application 820, a conductor application 830, and an external server application 840. In the embodiment illustrated in FIG. 8, internal client application 810 and connector application 820 are disposed within a secure network 850, and conductor application 830 and external server application 840 are disposed outside of secure network 850. Connector application 820 and conductor application 830 may be substantially similar in configuration and operation to connector application 120 and conductor application 130 in FIG. 1, except for the differences described below.

Internal client application 810 may be any network-accessible software application capable of accessing a server application, such as external server application 810, and providing a data stream over a TCP socket connection between internal client application 810 and connector application 820. For example, internal client application 810 may be a web browser or any other software application or computing device configured to run over a TCP connection protocol. External server application 810 may reside in a computing device inside secure network 850, for example in an instance of computing device 600 (described above), or across multiple computing devices. In some embodiments, external server application 810 resides on the same computing device as connector application 820 or, more typically, on a separate computing device.

External server application 840 may be any network-accessible resource, such as a network device, data source, and/or software application, capable of providing a data stream over a communication link to conductor application 830. For example, external server application 840 may include a web-based application, database, or any other software application or computing device configured to run over a TTCP connection protocol. External server application 840 may reside in a computing device, for example an instance of computing device 600 (described above), or across multiple computing devices. In some embodiments, external server application 840 may reside in the same computing device as conductor application 830, while in other embodiments, external server application 840 may reside in a separate computing device from conductor application 830.

Connector application 820 includes a mapping 829 that enables the routing of data packets between each internal client application 810 that is connected to connector application 820 and a specific external server application 840 that the internal client application 810 is accessing. For example, mapping 829 may map each internal client application 810 that is connected to connector application 820 to a specific external server application 840. In such embodiments, mapping 829 may map identifying information associated with internal client application 810 to identifying information associated with external server application 840. Identifying information associated with internal client application 810 may include an IP address and node number or a client socket (e.g., socket connection 811) associated with internal client application 810. Similarly, identifying information associated with external server application 840 may include an IP address and node number or a server socket (e.g., socket connection 841) associated with external server application 840.

Conductor application 830 includes a mapping 839 that further enables the routing of data packets between each internal client application 810 that is connected to connector application 820 and a specific external server application 840. For example, mapping 839 may map each internal client application 810 that is connected to connector application 820 to a specific external server application 840. Mapping 839 may have a similar configuration to that of mapping 829, and may include any suitable identifying information associated with internal client application 810 and external server application 840 to enable conductor application 830 to route data packets between external server application 840 and connector application 820. Thus, based on mapping 839, conductor application 830 can route data packets appropriately between connector application 820 and external server application 840.

Computer-implemented system 800 is configured to enable internal client application 810 to access external server application 840 without being modified. Consequently, internal client application 810 operates normally to access external server application 840, except to initiate a socket connection with connector application 820 instead of attempting to initiate a socket connection with external server application 840. Generally, a user configuration input can facilitate such a change.

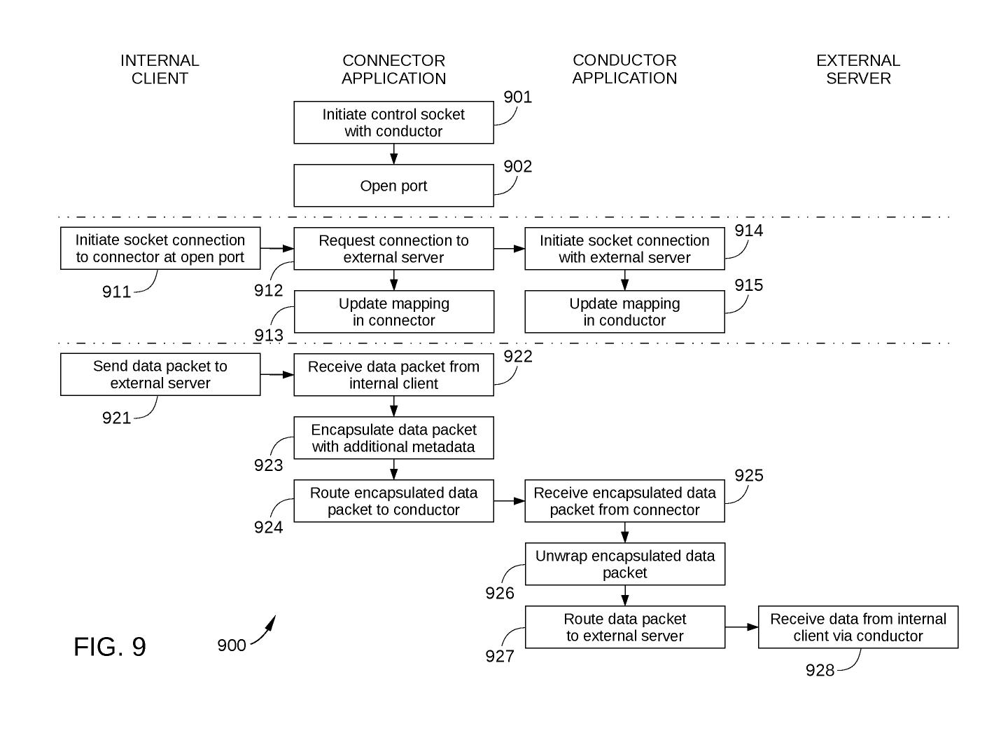

FIG. 9 sets forth a flowchart of method steps of a method 900 performed by a computer-implemented system for providing scalable access to resources located outside a firewall, according to one embodiment of the present invention. Although the method steps are described in conjunction with computer-implemented system 800 of FIG. 9, persons skilled in the art will understand that any computing device or system of computing devices configured to perform the method steps is within the scope of the invention. Steps 901-902 describe a startup phase, in which connector application 820 is first started up. Steps 911-915 describe a connection phase, in which a connection between a particular internal client application 810 and an external server application 840 is instantiated. In steps 921-928, data traffic is sent from internal client application 810 to external server application 840.

As shown in FIG. 9, method 900 begins at step 901, where connector application 820 receives a start command and initiates a control socket 825, which is a persistent connection, with conductor application 830. The start command may be received from a user of internal client application 810, for example when connector application 820 and internal client application 810 run on the same computing device. Alternatively, the start command may be generated remotely from the computing device on which internal client application 810 is running, such as when the user of internal client application 810 begins the process of connecting to external server application 840.

In step 902, connector application 820 opens a port 821 and listens on that port. In some embodiments, in step 902 connector application 820 opens and listens on a plurality of ports, where each is associated with a different known external target server application, such as external server application 840. In such embodiments, mapping 829 may map each of the ports opened in step 902 to a unique external server application 840, so that connector application 820 can route data packets between internal client application 810 and external server application 840.

In step 911, internal client application 810 initiates a socket connection 811 with connector application 820 at port 821. Internal client application 810 initiates socket connection 811 instead of attempting to initiate a socket connection with external server application 840 directly, such as when firewall 851 is configured to prevent internal client applications in secure network 850 from initiating certain socket connections through firewall 851. In some embodiments, a configuration input may be provided, for example by a user, to enable internal client application 810 to initiate socket connection 811 when internal client application 810 attempts to access external server application 840. In some embodiments, internal client application 810 may be configured to send IP address and port number information associated with external server application 840 to connector application 820 as part of step 912. In other embodiments, for example when mapping 829 already includes identifying information associated with external server application 840, internal client application 810 may initiate socket connection 811 conventionally without such additional identifying information. In such embodiments, internal client application 810 can operate in an unmodified configuration.

In step 912, in response to socket connection 811 being established, connector application 820 sends a request to conductor application 830 via control socket 825 to initiate socket connection 841 with external server application 840. In some embodiments, the request includes an IP address and port number associated with external server application 840.

In step 913, connector application 820 updates mapping 829 when applicable. For example, in embodiments in which a particular supplemental socket connection 827 is reserved for data traffic between internal client application 810 and external application 840, connector application 820 may update mapping 829 so that the particular supplemental socket connection 827 is mapped to socket connection 811 or to an IP address and port number associated with internal client application 810. Alternatively, connector application 820 may update mapping 829 so that socket connection 811 or an IP address and port number associated with internal client application 810 is mapped to socket connection 841 or an IP address and port number associated with external server application 840.

In step 914, conductor application 830 receives the request from connector application 820 and initiates socket connection 841 with external server application 840.

In step 915, conductor application 830 updates a mapping 839 that enables conductor application 830 to route data packets between internal client application 810 external server application 840, even when multiple internal client applications 810 are connected to connector application 820 and/or when multiple external server applications 840 are connected to conductor application 830. In some embodiments, mapping 839 maps identifying information associated with internal client application 810 to identifying information associated with external server application 840. For example, identifying information associated with internal client application 810 may include an IP address and node number or a client socket (e.g., socket connection 811) associated with internal client application 810. Similarly, identifying information associated with external application 840 may include an IP address and node number or a server socket (e.g., socket connection 841) associated with external application 840. Alternatively, when a particular supplemental socket connection 827 is reserved for data traffic between internal client application 810 and external application 840, mapping 839 may map the particular supplemental socket connection 827 to socket connection 841 or to an IP address and port number associated with external application 840. Based on mapping 839, conductor application 830 can route data packets appropriately between connector application 820 and external server application 840.

In step 921, internal client application 810 sends a data packet to external server application 840 via connector application 820 and socket connection 852. The data packet may be configured as a standard TCP packet. In step 922, connector application 820 receives the data packet via socket connection 811, which is an intra-network connection established within secure network 850.

In step 923, connector application 820 may encapsulate the data packet with additional metadata associating the data packet with a particular server socket of conductor 830, such as socket connection 841. Alternatively or additionally, the metadata may include any other identifying information indicating the server socket or external target server application that is associated with internal client application 810. In alternative embodiments, in which a specific supplemental socket connection 827 is reserved for data traffic between external server application 840 and internal client application 810, the data packet may not be encapsulated.

In step 924, connector application 820 routes the encapsulated data packet to conductor application 830 via control socket 825 or any supplemental socket connections 827 currently established between connector application 820 and conductor application 830. In embodiments in which the data packet is not encapsulated, connector application 820 routes the data packet to conductor application 830 via the specific supplemental socket connection 827 that is reserved for data traffic between external server application 840 and internal client application 810. In such embodiments, connector application 820 may use mapping 829 to determine via which specific supplemental socket connection 827 the data packet is routed to conductor application 830.

In step 925, conductor application 830 receives the encapsulated data packet from connector application 820 via control socket 825 or via any supplemental socket connections 827. In embodiments in which control socket 825 is reserved for control data, conductor application 830 receives the encapsulated data packet from connector application 820 via a supplemental socket connection 827. In embodiments in which the data packet is not encapsulated with additional metadata, conductor application 830 receives the data packet via the specific supplemental socket connection 827 reserved for data traffic between external server application 840 and internal client application 810.

In step 926, conductor application 830 unwraps the encapsulated data packet, and determines to which server socket connected to conductor 830 the unwrapped data packet should be routed. Conductor application 830 may make this determination based on mapping 839 and the metadata included in the encapsulated data packet, such as identifying information associating the data packet with a particular server socket connected to conductor application 830. Thus, conductor application 830 can correctly route the unwrapped data packet to the appropriate client socket, e.g., socket connection 841, and thereby to external server application 840. In embodiments in which the data packet is not encapsulated with additional metadata, conductor application 830 determines to which client socket the data packet should be routed based on the specific supplemental socket connection 827 by which the data packet was received. In such embodiments, mapping 839 may be configured to enable this determination.

In step 927, conductor application 830 routes the unwrapped data packet to external server application 840 via socket connection 841. In step 928, external server application 840 receives the unwrapped data packet from conductor application 830. In this way, a data packet is routed from internal client application 810 to external server application 840 via connector application 820 and conductor application 830.

Data packets can be similarly routed from external server application 840 to internal client application 810 via conductor application 830 and external server application 840. Thus, a data stream is enabled between internal client application 810 and external server application 840 without a direct connection therebetween through firewall 851.

FIG. 10 schematically illustrates an embodiment of a network packet 1000 encapsulated with additional metadata, according to an embodiment of the present invention. Data packet 1000 may include a TCP segment 1010 and a supplemental metadata portion 1020. TCP segment 1010 is configured to enable reliable, ordered, and error-checked delivery of a data stream between applications running on hosts communicating over an IP network, and may include a segment header 1011 and a data section 1012. The segment header 1011 includes formatted information that enables network packet 100 to be carried by a packet-switched network, such as source port bits, destination port bits, packet sequence number bits, checksum bits, and the like. The data section 1012 includes the payload data carried by network packet 1000.

Supplemental metadata portion 1020 includes additional metadata that enables routing of network packet 1000 between a connector application (such as connector application 120) and a conductor application (such as conductor application 130). Thus, metadata portion 1020 may include metadata that is supplemental to routing data typically included in a TCP data packet. For example, in some embodiments, metadata portion 1020 may include metadata indicating that network packet 1000 is associated with a particular external client application or socket connection that corresponds to the external client application. Alternatively or additionally, metadata portion 1020 may include the IP address and port associated with the socket connection that corresponds to the external client application. Furthermore, metadata portion 1020 may include metadata indicating that network packet 1000 is associated with a particular target server application or socket connection that corresponds to the target server application. Alternatively or additionally, metadata portion 1020 may include the IP address and port of the socket connection that corresponds to the target server application.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

While the foregoing is directed to embodiments of the present invention, other and further embodiments of the invention may be devised without departing from the basic scope thereof, and the scope thereof is determined by the claims that follow.

We claim:

1. A computer-readable medium including instructions that, when executed by a processing unit disposed inside a secure network, cause the processing unit to perform the steps of:
requesting a control socket with a conductor application, wherein the conductor application is running outside the secure network;
receiving a request from the conductor application via the control socket for an intra-network connection with an application that is running inside the secure network;
initiating the intra-network connection with the application that is running inside the secure network;
initiating a supplemental socket with the conductor application, wherein the supplemental socket is configured for transmitting application data associated with the application that is running inside the secure network;
mapping the intra-network connection to an external client application that is associated with the request for the intra-network connection;
receiving an incoming data packet from the conductor application via the supplemental socket, wherein the incoming data packet originates from the external client application; and
routing the incoming data packet to the application running inside the secure network via the intra-network connection.

2. The computer-readable medium of claim 1, wherein the control socket, the intra-network connection, and the supplemental socket each comprise a transmission control protocol (TCP) connection.

3. The computer-readable medium of claim 1, wherein routing the incoming data packet is based on the mapping of the intra-network connection to the external client application.

4. The computer-readable medium of claim 1, wherein the conductor application receives the incoming data packet via a client socket established between the external client application and the conductor application.

5. The computer-readable medium of claim 4, wherein mapping the intra-network connection to the external client application comprises associating the intra-network connection with the client socket;

6. The computer-readable medium of claim 5, further comprising instructions that, when executed by a processing unit disposed inside a secure network, cause the processing unit to perform the step of routing the incoming data packet to the application running inside the secure network based on the mapping of the intra-network connection to the external client application.

7. The computer-readable medium of claim 1, wherein the application running inside the secure network is not running on the processing unit.

8. The computer-readable medium of claim 1, further comprising instructions that, when executed by a processing unit disposed inside a secure network, cause the processing unit to perform the step of receiving a request from the conductor application via the control socket for an additional supplemental socket with the conductor application in response to a change in data traffic between the external client application and the application running inside the secure network, wherein the additional supplemental socket is configured for transmitting application data associated with the application that is running inside the secure network.

9. The computer-readable medium of claim 8, further comprising instructions that, when executed by a processing unit disposed inside a secure network, cause the processing unit to perform the steps of:
receiving an outgoing data packet from the application running inside the secure network via the intra-network connection; and
routing the outgoing data packet to the conductor application via the supplemental socket based on the mapping of the intra-network connection to the external client application.

10. The computer-readable medium of claim 1, further comprising instructions that, when executed by a processing unit disposed inside a secure network, cause the processing unit to perform the steps of:
receiving an outgoing data packet from the application running inside the secure network via the intra-network connection;
encapsulating the outgoing data packet with metadata that associates the outgoing data packet with the external client application; and
routing the outgoing data packet to the conductor application via the supplemental socket based on the metadata.

11. The computer-readable medium of claim 1, wherein the incoming data packet comprises an encapsulated data packet that includes metadata that associates the incoming data packet with the application that is running inside the secure network.

12. The computer-readable medium of claim 11, further comprising instructions that, when executed by a processing unit disposed inside a secure network, cause the processing unit to perform the step of extracting the metadata from the incoming data packet, wherein routing the incoming data packet to the application running inside the secure network is based on the metadata.

13. A computer-readable medium including instructions that, when executed by a processing unit disposed outside a secure network, cause the processing unit to perform the steps of:
receiving a request for a control socket with a connector application and establishing the control socket with the connector application, wherein the connector application is running inside the secure network;
receiving a request from the connector application via the control socket to make an application that is running inside the secure network available to any client application running outside the secure network;
receiving a request from an external client application for a client socket and establishing the client socket with the external client application;
mapping the client socket to the connector application;
sending a request to the connector application to establish an intra-network connection with the application that is running inside the secure network;
receiving a request via the control socket for a supplemental socket with the connector application, wherein the supplemental socket is configured for transmitting application data associated with the application that is running inside the secure network;
establishing the control socket with the connector application;
receiving an incoming data packet from the external client application via the client socket; and
routing the incoming data packet to the connector application via the supplemental socket.

14. The computer-readable medium of claim 13, further comprising instructions that, when executed by a processing unit disposed inside a secure network, cause the processing unit to perform the step of routing the incoming data packet to the connector application based on the mapping of the external client application to the intra-network connection.

15. The computer-readable medium of claim 13, wherein making the application that is running inside the secure network available to any client application comprises opening an advertised port outside the secure network.

16. The computer-readable medium of claim 13, further comprising instructions that, when executed by a processing unit disposed inside a secure network, cause the processing unit to perform the step of requesting via the control socket an additional supplemental socket with the connector application, wherein the additional supplemental socket is configured for transmitting application data associated with the application that is running inside the secure network.

17. The computer-readable medium of claim 16, wherein the requesting is made in response to a change in data traffic between the external client application and the application running inside the secure network.

18. The computer-readable medium of claim 13, further comprising instructions that, when executed by a processing unit disposed inside a secure network, cause the processing unit to perform the steps of:
receiving a request from a second external client application for a second client socket;
establishing the second client socket with the external client application; and
mapping the second client socket to the connector application.

19. The computer-readable medium of claim 18, further comprising instructions that, when executed by a processing unit disposed inside a secure network, cause the processing unit to perform the step of requesting via the control socket a second supplemental socket with the connector application, wherein the second supplemental socket is configured for transmitting application data between the application that is running inside the secure network and the second external client application.

20. The computer-readable medium of claim 13, wherein the external client application is not running on the processing unit.

21. The computer-readable medium of claim 13, wherein mapping the client socket to the connector application comprises associating the supplemental socket with the external client application.

22. The computer-readable medium of claim 21, further comprising instructions that, when executed by a processing unit disposed inside a secure network, cause the processing unit to perform the steps of:
receiving an outgoing data packet from the connector application via the supplemental socket; and
routing the outgoing data packet to the external client application via the client socket based on the association of the supplemental socket with the external client application.

23. The computer-readable medium of claim 13, further comprising instructions that, when executed by a processing unit disposed inside a secure network, cause the processing unit to perform the steps of:
receiving an outgoing data packet from the connector application via the supplemental socket, wherein the outgoing data packet comprises an encapsulated data packet that includes metadata that associates the outgoing data packet with the external client application; and
routing the outgoing data packet to the external client application.

24. The computer-readable medium of claim 23, wherein routing the outgoing data packet to the external client application comprises:
extracting the metadata from the incoming data packet; and
routing the outgoing data packet to the external client application based on the metadata.

25. The computer-readable medium of claim 13, further comprising instructions that, when executed by a processing unit disposed inside a secure network, cause the processing unit to perform the step of encapsulating the incoming data packet with metadata that associates the incoming data packet with the external client application.
